(19) United States
(12) Patent Application Publication
(10) Pub. No.: US 2025/0113823 A1
(43) Pub. Date: Apr. 10, 2025

(54) Arthropod Control Compositions

(71) Applicant: FIRMENICH SA, TE Heerlen (NL)

(72) Inventors: Vincent HARRACA, Satigny (CH); Maud REITER, Satigny (CH); Julien COULOMB, Satigny (CH); Eric FREROT, Satigny (CH)

(73) Assignee: FIRMENICH SA, Satigny (CH)

(21) Appl. No.: 18/730,394

(22) PCT Filed: Jan. 17, 2023
(86) PCT No.: PCT/EP2023/050968

§ 371 Date: Jul. 19, 2024

(30) Foreign Application Priority Data
Jan. 19, 2022 (EP) 22152173.5

(51) Int. Cl. A01N 31/16; A01P 7/04

(52) U.S. Cl. CPC A01N 31/16; A01P 7/04

(57) ABSTRACT

The present invention relates to arthropod control compositions, methods and uses to control arthropods as well as arthropod control articles comprising the same.

### TECHNICAL FIELD

The present invention relates to arthropod control compositions, methods and uses to control arthropods as well as arthropod controlling articles comprising the same.

### BACKGROUND

Many mammals, including humans, are suffering from the action of arthropods. Some arthropods, such as for example mosquitoes and ticks, are not desirable for vertebrates such as mammals and in particular human subjects as they bite and, consequently, cause itching, transmission of diseases and/or germs or may be the cause for other diseases and/or conditions. Similarly, other pests indirectly affect human activity or society by eating, parasitizing, or destroying plant materials that are used as food, feed or raw materials. Still further pests are involved in the destruction or weakening of furniture or structures used or built by humans. These damages may directly be attributed to the arthropods or by their capability of spreading germs causing such issues.

Arthropod control compositions include active substances and when applied to skin, clothing, or other surfaces, they may discourage arthropods from landing or climbing on that surface. Arthropod control agents help preventing and controlling the outbreak of arthropod-borne diseases, such as malaria, etc.

Some of the known arthropod controlling agents and composition, however, have certain drawbacks as they can have negative effects, i.e. negative olfactive properties, such as no or bad smell, or in turn only weak arthropod controlling, in particular arthropod repelling properties.

There is a need to provide arthropod control compositions that have both good olfactive properties, i.e. a good hedonic effect, and good arthropod controlling, in particular arthropod repelling properties.

The prior art does not disclose or suggest the arthropod control compositions according to the present invention.

### FIGURE LEGEND

FIG. 1: Percentage of mosquitoes Aedes aegypti escaping over time the chamber treated with a stimulus. The four stimuli were the solvent propan-1,2-diol (grey triangles and dotted line), N,N-diethyl-meta-toluamide (medium grey diamonds), 2,6-dimethoxy-4-methylphenol (light gray squares) and 1,2,3-trimethoxy-5-propylbenzene (black circles). Each stimulus was injected during 40 min thanks to a forced evaporation system in the treated chamber containing the mosquitoes, causing their movement toward the untreated refuge chamber. Each point represents the mean number of mosquitoes in the untreated chamber (n=57, 6, 4 and 4 respectively)±SD at 10 min intervals.

### DETAILED DESCRIPTION

The present invention provides arthropod, preferably insect, control composition comprising a compound of formula

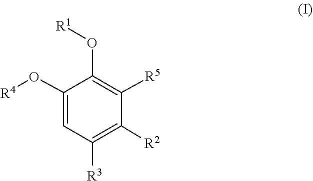

in the form of any one of its stereoisomers or a mixture thereof and wherein, R¹ is a hydrogen atom, a C₁₋₃ alkyl group or a C(═O)(O)ₙR^{1′} wherein n is 0 or 1 and R^{1′} is a C₁₋₃ alkyl group; R² is an hydrogen atom, a hydroxy group, an acetyl group, a formyl group, a nitrile group, a methyl group, or a methoxy group; R³ is a hydrogen atom, a C₄₋₇ oxacycloalkyl or oxacycloalkenyl group, each optionally substituted with a C₁₋₃ alkyl or a methylene group, a C₁₋₅ alkyl or C₂₋₅alkenyl group, each optionally substituted by an oxo group, a COOH group, an acetate group, a COOMe group, a COOEt group or a OR^{3′} group wherein R^{3′} is a hydrogen atom or C₁₋₁₀ alkyl group or a C₂₋₁₀ alkenyl group; R⁴ is a hydrogen atom or a C₁₋₃ alkyl group; R⁵ is a hydrogen atom, a C₂₋₃ alkenyl group, a hydroxymethyl group or a OR^{5′} group wherein R^{5′} is a hydrogen atom or a C₁₋₃ alkyl group; or R¹ and R^{4,} when taken together, are a CH₂C(═O)CH₂ group, a methanediyl group or a 2-oxopropane-1,1-diyl group;
provided that
   when R⁵ is a hydrogen atom; then R¹, R² and R³ are not a hydrogen atom;
when R⁵ is a hydrogen atom; R¹ is a hydrogen atom or a methyl group and R⁴ is a methyl group; then R³ is not an unsubstituted C₁₋₅ alkyl or C₁₋₅ alkenyl group;
when R³ is a formyl group; then R¹ and R⁴ is not a methyl group and R⁵ is not a hydrogen atom;
when R¹ is a hydrogen atom and R⁵ is a methoxy group; then R³ is not a formyl group; an acetyl group or a 2-carboxyvinyl group;
when R² is a methoxy group; then R³ is not a prop-1-en-1-yl group;
4-hydroxy-3-methoxybenzaldehyde, 4-butoxymethyl-2-methoxyphenol, 4-(4-hydroxy-3-methoxyphenyl)-2-butanone, 3-(4-hydroxy-3-methoxyphenyl)prop-2-enal, 4-hydroxy-3-methoxybenzaldehyde and 3-(3,4-dimethoxyphenyl)prop-2-enoic acid are excluded.

Preferably, R¹ is a hydrogen atom, a C₁₋₃ alkyl group or a C(═O)(O)ₙR^{1′} wherein n is 0 or 1 and R^{1′} is a C₁₋₃ alkyl group; R² is an hydrogen atom, a hydroxy group, or a methoxy group; R³ is a hydrogen atom, a C₄₋₇ oxacycloalkyl or oxacycloalkenyl group, each optionally substituted with a C₁₋₃ alkyl or a methylene group, a C₁₋₅ alkyl or C₂₋₅ alkenyl group, each optionally substituted by an oxo group, a COOH group, or a OR^{3′} group wherein R^{3′} is C₁₋₁₀ alkyl group or a C₂₋₁₀ alkenyl group; R⁴ is a hydrogen atom or a C₁₋₃ alkyl group; R⁵ is a hydrogen atom, a C₂₋₃ alkenyl group, or a OR^{5′} group wherein R^{5′} is or a C₁₋₃ alkyl group; or R¹ and R⁴, when taken together, are a CH₂C (=O)CH₂ group, a methanediyl group or a 2-oxopropane-1,1-diyl group.

The term “optionally” is understood that a certain group to be optionally substituted can or cannot be substituted with a certain functional group.

The terms “alkyl” and “alkenyl” are understood as comprising branched and linear alkyl and alkenyl groups. The terms “alkenyl” and “oxacycloalkenyl” are understood as comprising 1 or 2 olefinic double bonds, preferably 1 olefinic double bond.

The term “oxo group” are understood as comprising any group of formula ═O; i.e. such as a ketone or an aldehyde. In other words, a C₁₋₅ alkyl group optionally substituted an oxo group is a alkyl group having from 1 to 5 carbon and one of this carbon atoms, even the terminal carbon, may be substituted by a ═O group instead of two hydrogen atom.

By the term “oxacycloalkyl or oxacycloalkenyl group”, it is meant the normal meaning in the art; i.e. a heterocyclic group wherein the heteroatom is an oxygen; e.g. a pyranyl or a furanyl group.

For the sake of clarity, by the expression “any one of its stereoisomers or a mixture thereof”, or the similar, it is meant the normal meaning understood by a person skilled in the art, i.e. that the compound of formula (I) can be a pure enantiomer or diastereomer. In other words, the compound of formula (I) may possess one or several stereocenters and each of said stereocenter can have two different stereochemistries (e.g. R or S). The compound of formula (I) may even be in the form of a pure enantiomer or in the form of a mixture of enantiomers or diastereoisomers. The compound of formula (I) can be in a racemic form or scalemic form. Therefore, the compound of formula (I) can be one stereoisomer or in the form of a composition of matter comprising, or consisting of, various stereoisomers.

According to any one of the above embodiments of the invention, said compound of formula (I) may possess at least one double bond which can be in the form of its E or Z isomer or of a mixture thereof, e.g. the invention comprises compositions of matter consisting of one or more compounds of formula (I), having the same chemical structure but differing by the configuration of the double bond. In particular, compound (I) can be in the form of a mixture consisting of isomers E and Z and wherein said isomers E represent at least 50% of the total mixture, or even at least 60%, or even at least 70%, or even at least 75% (i.e a mixture E/Z comprised between 75/25 and 100/0).

According to any one of the above embodiments of the invention, R⁵ may be a OR^{5′} group wherein R^{5′} is a C₁₋₃ alkyl group. In other word, compound of formula (I) is of formula

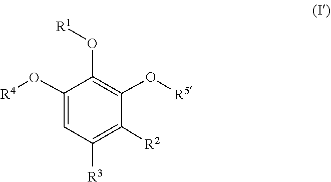

Wherein R¹, R², R³, R⁴ and R^{5′} have the same meaning as defined above. Particularly, R^{5′} is a methyl or an ethyl group. Even more particularly, R^{5′} is a methyl group.

According to any one of the above embodiments of the invention, R¹ may be a hydrogen atom, or a C₁₋₃ alkyl group. Particularly, R¹ may be a hydrogen atom, or a methyl or an ethyl group. Even more particularly, R¹ may be a hydrogen atom, or a methyl group.

According to any one of the above embodiments of the invention, R² may be a hydrogen atom.

According to any one of the above embodiments of the invention, R⁴ may be a methyl or an ethyl group. Even more particularly, R⁴ may be a methyl group.

According to any one of the above embodiments of the invention, R³ may be a hydrogen, a C₄₋₅ oxacycloalkyl or oxacycloalkenyl group optionally substituted with methyl or a methylene group, a C₁₋₄ alkyl or C₂₋₄ alkenyl group, each optionally substituted by an oxo group, a COOH group or a OR^{3′} group wherein R^{3′} is a C₁₋₁₀ alkyl group.

To the best knowledge of the inventors the composition of the first aspect of the invention has not previously been disclosed or speculated as having arthropod control properties. Moreover the composition as claimed herein has both arthropod control properties and desirable hedonic profile and therefore combines both perfuming and arthropod controlling properties in a single composition.

According to any one of the above embodiments of the invention, the compound is selected from a list consisting of: 2,6-dimethoxy-4-[prop-1-enyl]phenol (CAS: 20675-95-0), 4-allyl-2,6-dimethoxyphenol (CAS: 98954-35-9), 1,2,3-trimethoxy-5-[1-propen-1-yl]benzene (CAS: 487-12-7), 1,2,3-trimethoxy-5-propylbenzene (CAS: 41564-88-9), 1,2,4-trimethoxybenzene (CAS: 135-77-3), 2,6-dimethoxy-4-propylphenol (CAS: 6766-82-1), 2,6-dimethoxy-4-methylphenol (CAS: 6638 May 7), 3-(3,4,5-trimethoxyphenyl) prop-2-enoic acid (CAS: 90-50-6), 2-(4-hydroxy-3-methoxyphenyl) acetic acid (CAS: 306-08-1), methyl 3-(3,4-dimethoxyphenyl)-2-methylpropanoate (CAS: 148149-47-7), (2,3-dimethoxyphenyl) methanol (CAS: 5653-67-8), 2,3,4-trimethoxybenzaldehyde (CAS: 2103-57-3), 3,4,5-trimethoxybenzaldehyde (CAS: 86-81-7), 2-ethoxy-4-(methoxymethyl) phenol (CAS: 5595-79-9), 2-ethoxy-4-(ethoxymethyl) phenol (CAS: 71119 Jul. 8), 1,2-dimethoxy-4-prop-1-enylbenzene (CAS: 93-16-3), 1,2,3-trimethoxy-5-methylbenzene (CAS: 6443-69-2), 2,6-dimethoxy-4-methylphenol (CAS: 6638 May 7), 1-(2,3,4-trimethoxyphenyl) ethanone (CAS: 13909-73-4), 7-methyl-1,5-benzodioxepin-3-one (CAS: 28940 Nov. 6), 1,2-dimethoxy-3-prop-1-enylbenzene (CAS: 82895-28-1), 1,2,3-trimethoxy-5-propylbenzene (CAS: 41564-88-9), 2,3,4-trimethoxybenzonitrile (CAS: 43020-38-8), 3-ethoxy-4-methoxybenzaldehyde (CAS: 1131-52-8), 2,3,4-trimethoxyphenol (CAS: 19676-64-3), 1-(4-hydroxy-3-methoxyphenyl) ethanone (CAS: 498-02-2), 2-methoxy-4-(4-methylideneoxan-2-yl) phenol (CAS: 128489 Apr. 3), 4-(3,6-dihydro-4-methyl-2H-pyran-2-yl)-2-methoxy-phenol (CAS: 128489 Feb. 1) and mixtures thereof.

More preferably the compound is selected from a list consisting of: 6-dimethoxy-4-[prop-1-enyl]phenol (CAS: 20675-95-0), 4-allyl-2,6-dimethoxyphenol (CAS: 98954-35-9), 1,2,3-trimethoxy-5-[1-propen-1-yl]benzene (CAS: 487-12-7), 1,2,3-trimethoxy-5-propylbenzene (CAS: 41564-88-9), 1,2,4-trimethoxybenzene (CAS: 135-77-3), 2,6-dimethoxy-4-propylphenol (CAS: 6766-82-1), 2,6-dimethoxy-4-methylphenol (CAS: 6638 May 7), 3-(3,4,5-trimethoxyphenyl)prop-2-enoic acid (CAS: 90-50-6), 2-(4-hydroxy-3-methoxyphenyl) acetic acid (CAS: 306-08-1), methyl 3-(3,4-dimethoxyphenyl)-2-methylpropanoate (CAS: 148149-47-7), (2,3-dimethoxyphenyl)methanol (CAS: 5653-67-8), 2,3,4-trimethoxybenzaldehyde (CAS: 2103-57-3), 3,4,5-trimethoxybenzaldehyde (CAS: 86-81-7), 2-ethoxy-4-(methoxymethyl)phenol (CAS: 5595-79-9), 2-ethoxy-4-(ethoxymethyl) phenol (CAS: 71119 Jul. 8), and mixtures thereof.

A further aspect of the invention provides arthropod, preferably insect, control composition comprising 2-formyl-5-methoxyphenyl acetate [CAS: 62536-84-9].

It can be appreciated that each of the embodiments of the invention as provided herein may not comprise 100% of the composition of the invention. In such circumstances additional components can be used, for example to further improve the hedonic profile or adapt the hedonic profile for specific application by the consumer of the composition, solvents to aid the delivery of the composition of the invention, stabilizers and preservatives to improve the integrity and conservation of the composition as may be needed for anticipated use by the consumer. Further components include additional arthropod control co-ingredients as provided below

In a preferred embodiment of the invention the arthropod control composition has a good hedonic profile.

The present inventors have good appreciated that it may be desirable for arthropod control compositions to have an acceptable hedonic profile. This is because the compositions may be used in close proximity to a consumer and, as can be understood, any unpleasant hedonic profile may inhibit the use of the composition.

The term “arthropod” has the normal meaning for a skilled person in the technical field. Arthropods include invertebrate animals, such as insects, arachnids, and crustaceans, that have a segmented body and jointed appendages. Arthropods usually have a chitinous exoskeleton molted at intervals, and a dorsal anterior brain connected to a ventral chain of ganglia.

Arthropods in the present invention's understanding relate to undesired arthropods, meaning that their presence in the air, on the surface of an article, the surface of a plant or the surface of a vertebrate, such as a human subject or other mammal, preferably human subject, is not desired. Preferably undesired arthropods are pest arthropods that impact plants and animals, e.g. thrips, aphids, beetles, moth, mealybug, scale etc., more preferably pest arthropods that impact animals, e.g. ants, termites, cockroaches, flies, etc., even more preferably blood feeding arthropods that impact vertebrates, e.g. biting fly, bed bug, kissing bug, flea, lice, mosquitos and ticks, even more preferably mosquitos and ticks.

The reason why the presence of an arthropod is not desired might be that the arthropod's presence in the air is unpleasant to a subject, the contact of an arthropod on an article transfers diseases and/or germs or the arthropod bites an organism and causes itching, the transmission of diseases and/or germs or the arthropod feeding may be the cause for other diseases and/or conditions.

In a particular embodiment, the arthropod is an insect or an arachnid, preferably an insect.

The term “insect” has the normal understanding by a skilled person the technical field. An insect is described by a well-defined head, thorax, and abdomen, only three pairs of legs, and typically one or two pairs of wings

In a particular embodiment, the insect is a mosquito, biting fly, bedbug, kissing bug, flea, lice, ant, termite, cockroach, fly, aphid, beetle, thrips, moth, mealybug or scale bug, more preferably a mosquito.

The term “arachnid” has the normal understanding by a skilled person the technical field. An arachnid is described having a segmented body divided into two regions of which the anterior bears four pairs of legs but no antennae

In a particular embodiment, the arachnid is a tick, mite, chigger or spider, more preferably a tick.

The expression “control”, “arthropod control”, “insect control” or “arachnid control” or the like has the normal meaning for a skilled person in the technical field.

“Controlling” in the context of the present invention defines the ability of an arthropod controlling composition according to the present invention to attract, deter, kill or repel an arthropod, preferably deter or repel an arthropod and even more preferably repel an arthropod

“Attracting” according to the present invention defines the ability of an arthropod attractant composition according to the invention to increase or encourage contact or the presence of an arthropod at the arthropod attractant source, such as in the air, on the surface of an article or on the surface of a vertebrate, such as a human subject or other mammal, preferably an article such as a trapping device, the arthropod attractant compound or composition has been applied to.

“Repellency” according to the present invention defines the ability of an arthropod repellent composition according to the present invention to minimize, reduce, discourage or prevent approach or the presence of an arthropod at the arthropod repellent source, such as in the air, on the surface of an article or on the surface of a vertebrate, such as a human subject or other mammal, preferably human subject, to which the arthropod repellent compound or composition has been applied to.

“Deterring” according to the present invention defines the ability of an arthropod deterrent composition according to the invention to minimize, reduce, discourage or prevent contact or the presence of an arthropod at the arthropod deterrent source, such as in the air, on the surface of an article or on the surface of a vertebrate, such as a human subject or other mammal, preferably human subject, to which the arthropod deterrent compound or composition has been applied to. Typically, the deterrent effect is shown when used as feeding deterrent hindering a pest from subsequent food intake or oviposition or physical contact after an initial tasting of the arthropod deterrent compound or composition.

“Spatial Repellency” according to the present invention defines the ability of an arthropod repellent composition according to the present invention to minimize, reduce, discourage or prevent approach or the presence of an arthropod at the arthropod repellent source, such as in the air, on the surface of an article or on the surface of an vertebrate, such as a human subject or other mammal, preferably human subject, to which the arthropod repellent compound or composition has been applied to. Typically, the spatial repellency effect is shown when spatial repellent compound or composition released, sprayed, spread or diffused in the air or liquid hinder a pest from entering the zone in which the spatial repellent compound or composition is present. Repellence occurs therefore from a distance, the pest not necessarily entering in direct contact with the treated article or organism to protect.

“Killing” according to the present invention defines the ability of arthropod killing composition according to the present invention to kill an arthropod at the arthropod killing source, such as in the air, on the surface of an article or on the surface of a vertebrate, such as a human subject or other mammal, preferably human subject, to which the arthropod killing compound or composition has been applied to. When an arthropod killing composition is applied to a plant, an animal or human subject, it is applied in an amount which is killing to the arthropod but not to the subject.

In a particular embodiment, the arthropod control composition is an arthropod repelling composition, preferably an insect repelling composition, more preferably a mosquito repelling composition.

In a particular embodiment, the arthropod controlling source is the surface and/or the air in the vicinity of an article, preferably a candle, coil, an air care product, preferably an electric diffuser, wristband, patch, collar, ear tag, clothes, fabrics, papers, biochar, cardboard, cellulosic pads, bed nets, screen, curtains, furniture, walls, ground or paint, or the surface of a subject, preferably the surface of a vertebrate, such as a human subject or other mammal, preferably human subject, i.e. the skin of a human subject treated with a product such as spray, aerosol, cream, roll on, wristband, lotion, soap, shampoo, sunscreen or patch or a cloth treated with a product such as laundry powder, liquid detergent, spray, lotion, powder.

The arthropod controlling effect according to the present invention is determined on mosquitoes using an adapted Warm Body assay as defined in Kröber T, Kessler S, Frei J, Bourquin M, Guerin PM. An in vitro assay for testing mosquito controlling compounds employing a warm body and carbon dioxide as a behavioral activator. J Am Mosq Control Assoc. 2010; 26: 381-386. Further information is provided in the accompanying examples

The controlling effect, repellence & spatial repellence, according to the present invention is determined by testing the Warm Body assay against the yellow fever mosquito, Aedes aegypti Rockefeller strain. A. aegypti is a model organism for controlling tests and one of the recommended model organisms by the World Health Organization (WHO) as it is a very aggressive, anthropophilic mosquito species that shows generally low sensitivity to arthropod controlling compounds. Observations of controlling efficacy were made on host-seeking females of uniform age, 5 to 10 days old selected as mentioned in the publication mentioned hereinabove. Tested hungry females had access to 10% sugar solution but were not blood-fed. Further information is provided in the accompanying examples.

The published protocol has been adapted in not manually counting the landing mosquitoes but automatically using an automatic counting software, the switch from Anopheles gambiae to A. aegypti led to a decrease of mosquitoes' number placed in the tested cage due to the size difference (i.e. 30 mosquitoes instead of 50) and to an increase of lighting as A. aegypti is a diurnal mosquitoes (i.e. 150 lux instead of 4 lux). Further information is provided in the accompanying examples.

The controlling effect, repellence & spatial repellence, according to the present invention is also determined according to an arm in the box method adapted from the WHO Guidelines for efficacy testing of mosquito repellents for human skin (WHO/CDS/NTD/WHOPES/2009.4). The readiness of 100 hungry female mosquitoes A. aegypti to a test substance is assessed by comparing the results of an untreated arm to a treated in when inserted into the cage (40×40×40 cm) for 30 seconds (negative control) three times. Further information is provided in the accompanying examples.

The activity for substances to repel arachnids such as ticks may be assessed using the protocol of the in-vitro Warm Plate Assay as defined in Kröber T, Bourquin M, Guerin PM. 2013. A standardized in vivo and in vitro test method for evaluating tick repellents. Pestic. Biochem. Phys. 107 (2): 160-168.

In a particular embodiment, the amount and selection of the substance is in a way that it contributes, enhances or improves both, the arthropod control activity and the hedonic character of the composition.

In one embodiment, the arthropod control composition may further comprise an arthropod control co-ingredient. By “arthropod control co-ingredient” is understood an ingredient capable of imparting additional arthropod controlling benefits to the arthropod controlling effect of the composition herein described.

In one embodiment, the substance herein described is capable to modify, enhance or improve the arthropod controlling effect of the arthropod control co-ingredient, e.g. by reducing the amount of the arthropod control co-ingredient within a composition. This can be particularly beneficial in case the arthropod control co-ingredient is harmful to human subjects at a certain dose or in case the arthropod control co-ingredient has negative olfactive properties at a certain dose.

According to a particular embodiment, the combination of the substance herein described and an arthropod control co-ingredient results in a synergistic arthropod controlling effect.

According to a particular embodiment, the combination of substance herein described and an arthropod control co-ingredient results in a modified, pleasant, enhanced or improved olfactory impression of the overall composition in comparison to its single ingredients.

According to one embodiment arthropod control co-ingredient is selected from the group consisting of: N,N-diethyl-3-methylbenzamide (DEET), ethyl butylacetylaminopropionate (IR3535); para-menthan-3,8-diol (PMD); 1-(1-methylpropoxycarbonyl)-2-(2-hydroxaethyl) piperidin (picaridin); Cedarwood oil China, Cedarwood oil Texas, Cedarwood oil Virginia, Cinnamon oil, Citronella oil, Cornmint oil, Cymbopogon winterianus oil fractionated hydrated cyclized, decanoic acid, Eucalyptus citriodora oil Eucalyptus citriodora oil hydrated cyclized, eugenol, Garlic oil, geraniol, Geranium oil, Lavender, Lavandula hybrida oil, Lavandin oil, Lemon oil, Lemongrass oil, Margosa extract, Metofluthrin, mixture of cis-and trans-p-menthane-3,8 diol, N,N-diethyl-meta-toluamide, nonanoic acid, Rosemary oil, Thyme oil, Wintergreen oil, 2,3,4,5-bis (butyl-2-ene)tetrahydrofurfural (MGK Repellent 11), cineole, cinnamaldehyde, citronellal, citronellol, coumarin, dibutyl phthalate, diethyl phthalate, dimethyl anthranilate, dimethyl phthalate, ethyl vanillin, Eucalyptus oil, delta-octalactone, delta-nonalactone, delta-decalactone, delta-undecalactone, delta-dodecalactone, gamma-octalactone, gamma-nonalactone, gamma-decalactone, gamma-undecalactone, gamma-dodecalactone, hydroxy citronellal, Lime oil, limonene, linalool, methyl anthranilate, Mint oil, myrcene, Neem oil, sabinene, β-caryophyllene, (1H-indol-2-yl)acetic acid, anethole, Anise oil, Basil oil, Bay oil, camphor, ethyl salicylate, Evergreen oils (pine oil), (1,3,4,5,6,7-hexahydro-1,3-dioxo-2H-isoindol-2-yl)methyl 2,2-dimethyl-3-(2-methylprop-1-enyl)cyclopropanecarboxylate (d-Tetramethrin), 3-Allyl-2-methyl-4-oxocyclopent-2-enyl-2,2-dimethyl-3-(2-methylprop-1-enyl)-cyclopropanecarboxy late (d-Allethrin), α-cyano-3phenoxybenzyl, 3-(2,2-dichlorovinyl)-2,2-dimethylcyclopropanecarboxylate (Cypermethrin), 2-methyl-4-oxo-3-(prop-2-ynyl)cyclopent-2-en-1-yl 2,2-dimethyl-3-(2-methylprop-1-enyl)cyclopropanecarboxylate (Prallethrin), Acetamiprid, Azadirachtin, Bendiocarb, Bifenthrin, boric acid, Chlorpyrifos, Deltamethrin, Diazinon, Dichlorvos, eugenol, Fipronil, Imidacloprid, linalool, Malathion, Maltodextrin, Metofluthrin, Nicotine, Permethrin, Pyrethrins, Pyrethroids, Rotenone, silicium dioxide (Kieselguhr), S-Methoprene, Spinosad (Spinosyn A), Spinosyn D, Tetramethrin, Transfluthrin, 1-(2,6,6-trimethylcyclohex-2-en-1-yl) but-2-en-1-one, 3-butylidene-2-benzofuran-1-one, 4-ethenyl-2-methoxyphenol, Cognac oil green, Labdanum extract (Cistus spp.), 5-pentyloxolan-2-one, chromen-2-one, 3,7-dimethylocta-2,6-dienal, 4-hydroxy-3-methoxybenzaldehyde, 2-methyl-5-prop-1-en-2-ylcyclohex-2-en-1-one, Mentha spicata oil, 6-hexyloxan-2-one, 5-methyl-2-propan-2-ylcyclohexyl]acetate, Nigella damascena oil, 2-phenylethanol, 6-pentyloxan-2-one, (4-methoxyphenyl)methyl acetate, Syzygium aromaticum oil, 3,4,4a,5,6,7,8,8a-octahydrochromen-2-one, 3,7,7-trimethylbicyclo[4.1.0]hept-3-ene, 2-phenylethyl 2-methylpropanoate, methyl 2-(3-oxo-2-pent-2-enylcyclopentyl)acetate, 4-(2-methoxypropan-2-yl)-1-methylcyclohexene, Mentha piperita oil, 2-methoxy-4-[prop-1-enyl]phenol, 2-methyl-3-(4-propan-2-ylphenyl)propanal, (4-methoxyphenyl)methanol and mixtures thereof.

In a particular embodiment, the arthropod control co-ingredient is comprised in an amount of from 0.02 to 80 wt. %, more preferably in an amount of from 0.05 to 70 wt. %, even more preferably in an amount of from 0.1 to 60 wt. %, based on the total weight of the composition. Thereby, it is understood that the composition comprises the arthropod control co-ingredient in a minimum amount of at least 0.02 wt. %, at least 0.05 wt. % or at least 0.1 wt. % and a maximum amount of not more than 80 wt. %, not more than 70 wt. % or not more than 60 wt. %, based on the total weight of the composition.

In a particular embodiment, within the limitations of the amount of the substance in the composition as stated above, the substance in the composition of the invention and the arthropod control co-ingredient are comprised in the composition in a weight range of 90:10 to 10:90, preferably in a weight range of 80:20 to 20:80, more preferably in a weight range of 65:35 to 35:65 and most preferably in a weight range of 60:40 to 40:60. It is herein also understood that substance and the arthropod control co-ingredient can be comprised in the composition in any weight range combination as mentioned herein-before, such as 90:10 to 20:80, preferably 35:65 and more preferably 40:60, 80:20 to 10:90, preferably 35:65 and more preferably 40:60, 65:35 to 10:90, preferably 20:80 and more preferably 40:60 or 40:60 to 10:90, preferably 20:80 and more preferably 35:65.

In one embodiment, the arthropod control composition may further comprise perfume ingredients. Perfume ingredients are understood as contributing, modifying, enhancing or improving the olfactory character of the composition but do not contribute to, enhance or improve the arthropod controlling effect of the composition. Perfume ingredients providing such hedonic effects and suitable for use in the composition of the invention are known in the art and can be readily identified by the skilled person.

The arthropod control composition can further comprise a carrier. By “carrier” is understood a material with which the active compound is mixed or formulated to facilitate its application a locus or other object to be treated, or its storage, transport and/or handling. Said carrier may be of inorganic or organic or of synthetic natural origin. Said carrier may be a liquid or a solid.

As liquid carrier one may cite, as non-limiting examples, an emulsifying system, i.e. a solvent and a surfactant system, or a solvent commonly used in perfumery. A detailed description of the nature and type of solvents commonly cannot be exhaustive. However, one can cite as non-limiting examples, solvents such as butylene or propylene glycol, glycerol, dipropylene glycol and its monoether, 1,2,3-propanetriyl triacetate, dimethyl glutarate, dimethyl adipate 1,3-diacetyloxypropan-2-yl acetate, diethyl phthalate, isopropyl myristate, benzyl benzoate, benzyl alcohol, 2-(2-ethoxyethoxy)-1-ethanol, tri-ethyl citrate, 2-methylprop-1-ene and 2-(2-ethoxyethoxy)ethanol or mixtures thereof, particular suitable are dipropylene glycol, 2-methylprop-1-ene and 2-(2-ethoxyethoxy)ethanol and mixtures thereof.

For the compositions which comprise both a carrier, other suitable carriers than those previously specified, can be also ethanol, water/ethanol mixtures, limonene or other terpenes, isoparaffins such as those known under the trademark Isopar® (origin: Exxon Chemical) or glycol ethers and glycol ether esters such as those known under the trademark Dowanol® (origin: Dow Chemical Company) like Dowanol™ DPMA (Glycol Ether Acetate), or Augeo® Clean Multi (isopropylidene glycerol; origin: Solvay), or hydrogenated castors oils such as those known under the trademark Cremophor® RH 40 (origin: BASF).

Solid carrier is meant to designate a material to which the arthropod control composition or some element of the arthropod control composition can be chemically or physically bound. In general, such solid carriers are employed either to stabilize the composition, or to control the rate of evaporation of the compositions or of some ingredients. The use of solid carrier is of current use in the art and a person skilled in the art knows how to reach the desired effect. However, by way of non-limiting example of solid carriers, one may cite absorbing gums or polymers or inorganic material, such as porous polymers, cyclodextrins, wood based materials, organic or inorganic gels, clays, gypsum talc or zeolites.

As other non-limiting examples of solid carriers, one may cite encapsulating materials. Examples of such materials may comprise wall-forming and plasticizing materials, such as mono, di-or trisaccharides, natural or modified starches, hydrocolloids, cellulose derivatives, polyvinyl acetates, polyvinylalcohols, proteins or pectins, or other such materials. The encapsulation is a well-known process to a person skilled in the art, and may be performed, for instance, by using techniques such as spray-drying, agglomeration or yet extrusion; or consists of a coating encapsulation, including coacervation and complex coacervation technique.

As non-limiting examples of solid carriers, one may cite in particular the core-shell capsules with resins of aminoplast, polyamide, polyester, polyurea or polyurethane type or a mixture thereof (all of said resins are well known to a person skilled in the art) using techniques like phase separation process induced by polymerization, interfacial polymerization, coacervation or altogether (all of said techniques have been described in the prior art), optionally in the presence of a polymeric stabilizer or of a cationic copolymer.

Resins may be produced by the polycondensation of an aldehyde (e.g. formaldehyde, 2,2-dimethoxyethanal, glyoxal, glyoxylic acid or glycolaldehyde and mixtures thereof) with an amine such as urea, benzoguanamine, glycoluryl, melamine, methylol melamine, methylated methylol melamine, guanazole and the like, as well as mixtures thereof. Alternatively, one may use preformed resins alkylolated polyamines such as those commercially available under the trademark Urac® (origin: Cytec Technology Corp.), Cymel® (origin: Cytec Technology Corp.), Urecoll® or Luracoll® (origin: BASF).

Others resins one are the ones produced by the polycondensation of an a polyol, like glycerol, and a polyisocyanate, like a trimer of hexamethylene diisocyanate, a trimer of isophorone diisocyanate or xylylene diisocyanate or a Biuret of hexamethylene diisocyanate or a trimer of xylylene diisocyanate with trimethylolpropane (known with the tradename of Takenate®, origin: Mitsui Chemicals), among which a trimer of xylylene diisocyanate with trimethylolpropane and a Biuret of hexamethylene diisocyanate.

Many articles have been published relating to the encapsulation by polycondensation of amino resins, namely melamine-based resins with aldehydes. Such articles already describe the various parameters affecting the preparation of such core-shell microcapsules. These documents are known to the skilled person and the contents therein be used in the field of the present invention.

The present invention also relates to a method for arthropod, preferably insect, control which comprises bringing an arthropod, preferably insect, into direct contact or in contact with vapors of a composition as described hereinabove.

For the sake of clarity, the arthropod controlling composition according to the present invention can be applied to the air, to the surface of an article, the air in the vicinity of the surface of an article or the surface of a subject by usual methods known in the art such as spraying, applying, wearing or diffusing.

In a particular embodiment, the arthropod controlling composition according to the present invention is applied to the surface of an article, the air in the vicinity of the surface of an article or to the surface of an animal or subject.

In a particular embodiment, the article can be an arthropod control article as described hereinbelow and in particular, can be a candle, coil, an air care product, preferably an electric diffuser, wristband, patch, collar, ear tag, clothes, fabrics, papers, biochar, cardboard, cellulosic pads, bed nets, screen, curtains, furniture, paint, walls, ground, spray, aerosol, cream, roll on, wristband, lotion, soap, shampoo, sunscreen, laundry powder, liquid detergent, spray, lotion, powder.

In a particular embodiment, the surface of a subject is the surface of a human or animal subject, preferably the surface is a human subject, i.e. the skin of a human subject.

The present invention also relates to a use of a composition as defined hereinabove to control arthropods, preferably insects.

The present invention also relates to an arthropod control article comprising the arthropod control composition as described hereinabove.

By “arthropod control article” is understood to designate a consumer product which delivers at least an arthropod controlling effect to the surface or space to which it is applied (e.g. skin, hair, textile, or home surface). In other words, an arthropod controlling article according to the invention is a consumer product which comprises a functional formulation, as well as optionally additional benefit agents, corresponding to the desired consumer product, and an arthropod controlling amount of at least one of the substances. For the sake of clarity, said consumer product is a non-edible product.

The nature and type of the constituents of the consumer product do not warrant a more detailed description here, which in any case would not be exhaustive, the skilled person being able to select them on the basis of his general knowledge and according to the nature and the desired effect of said product.

Non-limiting examples of suitable consumer products include a perfume, such as a fine perfume, a splash or eau de parfum, a cologne or a shave or after-shave lotion or a cream or gel; a fabric care product, such as a liquid or solid detergent, a laundry powder, a fabric softener, a liquid or solid scent booster, a fabric refresher, an ironing water, a paper, a bleach, a carpet cleaner, a curtain-care product; a body-care product, such as a hair care product (e.g. a shampoo, a coloring preparation or a hair spray, a color-care product, a hair shaping product), a dental care product, a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); or a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc.); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner; a candle; a spray, a coil, an air care product, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint, more preferably a candle, a spray, a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint.

In a preferred embodiment of the invention, the consumer product is an air care product, preferably an electric diffuser. In this embodiment of the invention, the substance in the arthropod, preferably insect, control composition is present at certain quantities.

Some of the above-mentioned consumer products may represent an aggressive medium for the members of the substances, so that it may be necessary to protect the latter from premature decomposition, for example by encapsulation or by chemically binding it to another chemical which is suitable to release the invention's ingredient upon a suitable external stimulus, such as an enzyme, light, heat or a change of pH.

The invention will be described in further detail by way of the following non-limiting examples.

### EXAMPLES

### 1. Experimental Protocols and Methods Used Herein

### Warm Body Assay is the Small-Scale Test Used to Screen the Repellent Efficacy on Mosquitoes at 3-15 Concentrations at T0

Aedes aegypti is a model organism for controlling tests and one of the recommended model organisms by the World Health Organization (WHO) as it is a very aggressive anthropophilic mosquito species that shows generally low sensitivity to arthropod controlling compounds. Anopheles gambiae is also a model organism as it is anthropophilic and transmits malaria.

The controlling effect according to the present invention was assessed using an adapted Warm Body assay as defined in Kröber T, Kessler S, Frei J, Bourquin M, Guerin P M. 2010. J Am Mosq Control Assoc. 26: 381-386. In this in-vitro assay the number of mosquito landing on a warm body, simulating an attractive host treated with the tested stimuli, was measured in order to assess the repellence effect.

The published protocol has been adapted as the switch from Anopheles gambiae to Aedes aegypti led to a decrease of mosquitoes placed in the tested cage due to the size difference (i.e. 30 mosquitoes instead of 50) and to an increase of lighting since A. aegypti is a diurnal mosquitoes (i.e. 150 lux instead of 4 lux).

### Double Chamber Assay is the Small-Scale Test Used to Screen the Spatial Repellent Efficacy on Mosquitoes at One Concentration Between 0 and 40 Minutes

The goal of this assay was to reproduce at a smaller scale the validation test for spatial repellent as described in WHO (2013; ISBN 978 92 4 150502 4).

The assay consists of a transparent cage (1200×755×700 mm; ˜0.63 m³) covered by white paper. This cage is divided in two chambers of equal dimensions by a plasticized paper wall with square opening (200×200 mm) situated in the middle of the wall. At the beginning of the experiment, about 40 two-weeks old female Aedes aegypti mosquitoes are placed in the right chambers. Once the mosquitoes are settled inside this chamber (>5 min), the door between the chambers is opened. Then the stimulus is introduced into the mosquito chamber through a L-shape Teflon tube (40 mm) placed in the middle of the right Plexiglas wall. The stimulus is dispensed thanks to a Forced Evaporation System (Chappuis et al, 2015, DOI: 10.1021/acs.est.5b00692) at a rate of 0.1 mL/min in a nitrogen flow of 1 L/min, blended in a humid air flow of 9L/min before being carried to the L-shape Teflon tube. An air sucking system (˜150 L/min) is placed above the wall opening, between the two chambers (100 mm Ø), preventing the untreated chamber from being contaminated by the stimulus and limiting the stimulus accumulation in the treated chamber. The untreated chamber thus provides a “refuge” for the mosquitoes escaping the stimulus of treated chamber. Ten, 20, 30 and 40 minutes after the start of the stimulus injection, the number of mosquitoes that have moved to the untreated chamber is manually counted.

### Arm-in-Cage Test is the Large-Scale Test Used to Assess on Human Volunteer the Repellent Efficacy on Mosquitoes

The Arm in the box method was adapted from the WHO Guidelines for efficacy testing of mosquito repellents for human skin (WHO/CDS/NTD/WHOPES/2009.4). The readiness of 100 hungry female mosquitoes A. aegypti to probe is assessed by inserting the untreated arm of human volunteers into the cage (40×40×40cm) for 30 seconds (negative control) in order to determine probing activity. Then, the product is applied onto the skin of the forearm of the human volunteer (1 mL per 600 cm²) and after 5 minutes, this arm is inserted into the cage and exposed for 3 minutes. The assay take place in temperature (27±2° C.) and humidity (80±10% RH) regulated room on three different human volunteers.

### Free Flying Room Assay is the Large-Scale Test Used to Assess On Human Volunteer the Spatial Repellent Efficacy on Mosquitoes

The goal of this large-scale test is to assess the propensity of stimulus released in the air to protect a human volunteer by limiting the mosquito presence in a protected space and the number of landing/biting. The protocol used to carry the test is following the guidelines indicated in WHO (2013; ISBN 978 92 4 150502 4).

A group of 50 Aedes aegypti female mosquitoes were introduced in one chamber of 25 m³ one hour before the test started. The product was applied in the other chamber of 25 m³ (“treated chamber”) and let evaporate for 30 minutes. The test started when the window separating the two chambers was opened in a tilt-on manner for another 30 minutes. Twenty minutes after the window was opened, a volunteer entered in the “treated chamber” and sat down for 10 minutes, exposing the forearm for the last 3 minutes to determine the probing activity (Protective Efficacy). Then, the connecting window was closed and the number of mosquitoes in each of the chambers was counted (Spatial Repellency). The negative controls were carried out following the same procedure but without the application of the stimulus. Three replicates of each treatment and of the negative control were conducted with three different volunteers.

### Warm Plate Assay is the Small-Scale Test Used to Screen the Repellent Efficacy on Ticks at Different Concentrations at T0

Repellent efficacy of the different compounds was assessed against the castor bean tick, Ixodes ricinus L that can transmit both bacterial and viral pathogens. I. ricinus is one of the recommended model organisms mentioned by the Guidance on the European Biological Products Regulation [Vol II, Efficacy—Assessment & Evaluation (Parts B+C), v. 3.0, April 2018]. Observations of repellent efficacy were made on last stage nymphs.

The repellent efficacy was assessed using the protocol of the in-vitro Warm Plate Assay as defined in Kröber T, Bourquin M, Guerin P M. 2013. Pestic. Biochem. Phys. 107 (2): 160-168.

### 2. Results of Deterrence and Spatial Repellence Effect on Arthropods

### Warm Body Assay

On the sandblasted glass Petri dish covering the warm body (28.3 cm²), 100 μL of the compounds diluted at different concentrations in ethanol was applied. The number of mosquito landing on the warm body was counted for each stimulus and pure ethanol (solvent) as control.

All stimuli tested elicited a clear increase of repellence linked to the increase of the applied dose (Table 1, 2, 3 & 4). This really demonstrates a biological repellent effect of the different products on mosquito behavior.

TABLE 1
Percentage of repellence of mosquitoes Aedes aegypti landing on the
warm body baited with different stimuli at different concentrations. The nine stimuli tested
were 1,2,3-trimethoxy-5-[1-propen-1-yl]benzene [1123], 2,6-dimethoxy-4-[prop-1-
enyl]phenol [1124], 4-allyl-2,6-dimethoxyphenol [1191], 1,2,3-trimethoxy-5-
propylbenzene [1975], 2,6-dimethoxy-4-propylphenol [1502], 1-(3,4,5-trimethoxyphenyl)-N-[2-
[(3,4,5-trimethoxyphenyl)methylideneamino]ethyl]methanimine [1980] and (2-methoxy-4-
methylphenyl) methyl carbonate [1141]. Twelve to fifteen concentrations were assessed on
each stimulus, missing data points mentioned as n.d.. The mean number of mosquito landings
with the solvent only (0 mg/mL) is equal to 58 ± 3.3 landings in two minutes.

| | 0.0032 | 0.0071 | 0.016 | 0.0357 | 0.053 | 0.08 | 0.119 | 0.178 | 0.267 | 0.4 | 0.598 | 0.89 | 2 | 4.47 | 10 |
|---|---|---|---|---|---|---|---|---|---|---|---|---|---|---|---|
| | mg/mL | mg/mL | mg/mL | mg/mL | mg/mL | mg/mL | mg/mL | mg/mL | mg/mL | mg/mL | mg/mL | mg/mL | mg/mL | mg/mL | mg/mL |
| 1124 | 26% | 40% | 62% | 0% | 48% | 84% | 35% | 66% | 59% | 78% | 69% | 78% | 95% | 85% | 98% |
| 1141 | 24% | 39% | 17% | 13% | 50% | 39% | n.d. | 67% | n.d | 72% | n.d. | 98% | 89% | 87% | 91% |
| 1191 | 60% | 52% | 70% | 68% | 67% | 62% | 50% | 86% | 86% | 93% | 98% | 98% | 97% | 98% | 100% |
| 1123 | 28% | 10% | 63% | 45% | 81% | 67% | 71% | 83% | 90% | 91% | 95% | 90% | 98% | 100% | 98% |
| 1502 | 0% | 0% | 32% | 0% | 61% | 0% | 14% | 94% | 94% | 88% | 94% | 99% | 96% | 100% | 96% |
| 1975 | 33% | 10% | 0% | 66% | 30% | 93% | 36% | 83% | 87% | 94% | 99% | 95% | 96% | 98% | 96% |
| 1980 | 53% | 57% | 34% | 32% | 77% | 92% | 75% | 67% | 84% | 81% | 88% | 63% | 86% | 71% | 96% |

As displayed in Table 1, despite some variability in measurements, all seven compounds displayed a relevant reduction of the number of mosquito landings due to concentration. Indeed 4-allyl-2,6-dimethoxyphenol, 1,2,3-trimethoxy-5-[1-propen-1-yl]benzene, 1,2,3-trimethoxy-5-propylbenzene and 2,6-dimethoxy-4-propylphenol constantly limited the number of mosquito landings at <5 landings/minute at all concentrations above 0.0178% (Table 1). 4-allyl-2,6-dimethoxyphenol displayed very relevant results as it managed to reduce mosquito landing by ≥50% since the lowest concentrations assessed (Table 1). At the highest tested concentration (1%), all seven stimuli, i.e. 1,2,3-trimethoxy-5-[1-propen-1-yl]benzene, 2,6-dimethoxy-4-[prop-1-enyl]phenol, 4-allyl-2,6-dimethoxyphenol, 1,2,3-trimethoxy-5-propylbenzene, 2,6-dimethoxy-4-propylphenol, 1-(3,4,5-trimethoxyphenyl)-N-[2-[(3,4,5-trimethoxyphenyl)methylideneamino]ethyl]methanimine, (2-methoxy-4-methylphenyl) methyl carbonate, managed to reduce >90% of the number of landings (Table 1).

TABLE 2
Percentage of repellence of mosquitoes Aedes aegypti landing on the
warm body baited with different stimuli at different concentrations. The eight stimuli
tested were 2,6-dimethoxy-4-prop-1-enylphenol [1127], 1,2,4-trimethoxybenzene [1201], 2,6-
dimethoxy-4-methylphenol [1537] and 3-(3,4,5-trimethoxyphenyl)prop-2-enoic acid [1566].
Nine concentrations were assessed on each stimulus. The mean number of mosquito
landings with the solvent only (0 mg/mL) is equal to 52 ± 2.1 landings in two minutes.

| | 0.0032 | 0.016 | 0.0357 | 0.08 | 0.178 | 0.4 | 0.89 | 2 | 10 |
|---|---|---|---|---|---|---|---|---|---|
| | mg/mL | mg/mL | mg/mL | mg/mL | mg/mL | mg/mL | mg/mL | mg/mL | mg/mL |
| 1127 | 17% | 1% | 0% | 0% | 30% | 42% | 59% | 100% | 96% |
| 1201 | 46% | 82% | 58% | 72% | 63% | 79% | 95% | 89% | 96% |
| 1537 | 0% | 35% | 36% | 40% | 62% | 89% | 84% | 100% | 100% |
| 1566 | 0% | 20% | 22% | 0% | 30% | 81% | 69% | 57% | 96% |

As displayed in Table 2, since the lowest doses tested (0.00032% & 0.0016%), 1,2,4-trimethoxybenzene managed to decrease the number of mosquito landings by two folds. At a dose of 1%, all four tested stimuli, i.e. 2,6-dimethoxy-4-prop-1-enylphenol, 1,2,4-trimethoxybenzene, 2,6-dimethoxy-4-methylphenol and 3-(3,4,5-trimethoxyphenyl) prop-2-enoic acid, managed to reduce the number of mosquito landings from 29 landings/min to <1 landing/min (Table 2).

TABLE 3
Percentage of repellence of mosquitoes Aedes aegypti landing on the
warm body baited with different stimuli at different concentrations.

| | 0.016 mg/mL | 0.4 mg/mL | 10 mg/mL |
|---|---|---|---|
| 465 | 4% | 36% | 87% |
| 908 | 10% | 37% | 85% |
| 1125 | 32% | 78% | 92% |
| 1126 | 31% | 71% | 90% |
| 1195 | 56% | 69% | 100% |
| 1196 | 57% | 74% | 86% |
| 1204 | 46% | 83% | 92% |
| 1228 | 54% | 74% | 100% |
| 1232 | 0% | 32% | 86% |
| 1271 | 29% | 84% | 96% |
| 1303 | 16% | 21% | 100% |
| 1467 | 29% | 84% | 79% |
| 1468 | 64% | 74% | 90% |
| 1469 | 64% | 65% | 95% |
| 1472 | 31% | 81% | 100% |
| 1474 | 0% | 76% | 73% |
| 1478 | 0% | 76% | 73% |
| 1479 | 55% | 89% | 98% |
| 1480 | 66% | 61% | 100% |
| 1481 | 21% | 89% | 97% |
| 1482 | 31% | 82% | 96% |
| 1519 | 67% | 71% | 95% |
| 1527 | 69% | 76% | 71% |
| 1551 | 55% | 42% | 91% |
| 1553 | 60% | 85% | 43% |
| 1557 | 81% | 93% | 96% |
| 1558 | 86% | 89% | 86% |
| 1559 | 90% | 98% | 98% |
| 1561 | 9% | 37% | 84% |
| 1564 | 24% | 69% | 82% |
| 1567 | 54% | 86% | 98% |
| 1682 | 0% | 73% | 90% |
| 1698 | 45% | 88% | 100% |
| 1822 | 54% | 39% | 100% |
| 1967 | 0% | 12% | 81% |
| 1968 | 23% | 38% | 100% |
| 2240 | 0% | 47% | 94% |
| 2244 | 44% | 59% | 85% |
| 2247 | 39% | 44% | 98% |
| 2250 | 21% | 57% | 100% |
| 2263 | 52% | 96% | 97% |
| 2266 | 48% | 83% | 89% |
| 2267 | 0% | 81% | 96% |
| 2268 | 59% | 88% | 95% |
| 2269 | 18% | 70% | 100% |
| 2270 | 67% | 62% | 87% |
| 2272 | 0% | 77% | 89% |
| 2276 | 0% | 0% | 98% |

The forty-nine stimuli tested were 7-propyl-1,5-benzoodioxepin-3-one [465], 1-(5-propyl-1,3-benzodioxol-2-yl)ethanone [908], 1,2-dimethoxy-3-prop-1-enylbenzene [1125], 1,2,3-trimethoxy-5-prop-1-enylbenzene [1126], 1,2-dimethoxy-4-prop-1-enylbenzene [1195], 1,4-dimethoxy-2-[1-propen-1-yl]benzene [1196], 2,3,4-trimethoxyphenol [1204], 7-methyl-1,5-benzodioxepin-3-one [1228], isopropyl-2H,4H-1,5-benzodioxepin-3-one, 7- [1232], 2-ethoxy-4-(methoxymethyl)phenol [1271], 2-ethoxy-4-methylphenol [1303], 2-(4-hydroxy-3-methoxyphenyl)acetaldehyde [1467], 1-(4-hydroxy-3-methoxyphenyl)ethanone [1468], (2-ethoxy-4-formylphenyl) 2-methylpropanoate [1469], (2-formyl-5-methoxyphenyl) acetate [1472], blend of 4-(3,6-dihydro-4-methyl-2H-pyran-2-yl)-2-methoxy-phenol and 2-methoxy-4-(4-methylideneoxan-2-yl)phenol [1474], 2-methoxy-4-(5-methyl-3,6-dihydro-2H-pyran-2-yl)phenol [1478], 4-[(allyloxy)methyl]-2-ethoxyphenol [1479], 2-methoxy-4-(1-methoxyethyl)phenol [1480], 2-methoxy-4-(oxolan-2-yl)phenol [1481], 2-ethoxy-4-(ethoxymethyl)phenol [1482], 4-{3-[(2,6-dimethyl-7-octen-2-yl)oxy]-1-propen-1-yl}-2-methoxyphenol [1519], 3-(4-hydroxy-3-methoxyphenyl)pro-2-enal [1527], 8-hydroxy-7-methoxychromen-2-one [1551], 3-(4-hydroxy-3,5-dimethoxyphenyl)prop-2-enoic acid [1553], 2,4-dimethoxyacetophenone [1557], 2,4-dimethoxybenzaldehyde [1558], 2-hydroxy-4-methoxyacetophenone [1559], 3-(3,4-dimethoxyphenyl)propanoic acid [1561], 2-(3,4-dimethoxyphenyl)acetic acid [1564], 2-(4-hydroxy-3-methoxyphenyl)acetic acid [1567], 1,2,3-trimethoxy-5-prop-2-enylbenzene [1682], methyl 3-(3,4-dimethoxyphenyl)-2-methylpropanoate [1698], 1,2,3-trimethoxybenzene [1822], 3,4,5-trimethoxytoluene [1967], (3,4,5-trimethoxyphenyl)methanol [1968], 4-ethyl-2,6-dimethoxyphenol [2240], 2,6-dimethoxyphenol [2244], 3-(3,4,5-trimethoxyphenyl)-2-acetate [2247], 1,2,3-trimethoxy-5-methybenzene [2250], (2,3-dimethoxyphenyl)methanol [2263], 2,3,4-trimethoxybenzonitrile [2266], 2,3,4-trimethoxybenzaldehyde [2267], 3,4,5-trimethoxybenzaldehyde [2268], 1-(2,3,4-trimethoxyphenyl)ethanone [2269], 4-hydroxy-3,5-dimethoxybenzoic acid [2270], 3-ethoxy-4-methoxybenzaldehyde [2272] and 2-ethoxy-1,3-dimethoxybenzene [2276]. Three concentrations were assessed on each stimulus. The mean number of mosquito landings with the solvent only (0 mg/mL) is equal to 59 ± 8 landings in two minutes.

At the lowest concentration of 0.0016%, nineteen stimuli, i.e. 2-hydroxy-4-methoxyacetophenone, 2,4-dimethoxybenzaldehyde, 2,4-dimethoxyacetophenone, 3-(4-hydroxy-3-methoxyphenyl) prop-2-enal, 4-{3-[(2,6-dimethyl-7-octen-2-yl)oxy]-1-propen-1-yl}-2-methoxyphenol, 4-hydroxy-3,5-dimethoxybenzoic acid, 2-methoxy-4-(1-methoxyethyl) phenol, (2-ethoxy-4-formylphenyl) 2-methylpropanoate, 1-(4-hydroxy-3-methoxyphenyl)ethenone, 3-(4-hydroxy-3,5-dimethoxyphenyl)prop-2-enoic acid, 3,4,5-trimethoxybenzaldehyde, 1,4-dimethoxy-2-[1-propen-1-yl]benzene, 1,2-dimethoxy-4-prop-1-enylbenzene, 4-[(allyloxy)methyl]-2-ethoxyphenol, 8-hydroxy-7-methoxychromen-2-one, 2-(4-hydroxy-3-methoxyphenyl)acetic acid, 7-methyl-1,5-benzodioxepin-3-one, 1,2,3-trimethoxybenzene and (2,3-dimethoxyphenyl)methanol managed to reduce the number of mosquito landings by more than 50% (Table 3). At this concentration, three stimuli, i.e. 2,4-dimethoxyacetophenone, 2,4-dimethoxybenzaldehyde and 2-hydroxy-4-methoxyacetophenone, even managed to elicit a repellent effect above 80% (Table 3).

At the intermediate concentration of 0.04%, twenty two stimuli, i.e. 1,2-dimethoxy-3-prop-1-enylbenzene, 2,3,4-trimethoxyphenol, 2-ethoxy-4-(methoxymethyl) phenol, 2-(4-hydroxy-3-methoxyphenyl) acetaldehyde, (2-formyl-5-methoxyphenyl)acetate, blend of 4-(3,6-dihydro-4-methyl-2H-pyran-2-yl)-2-methoxy-phenol and 2-methoxy-4-(4-methylideneoxan-2-yl)phenol, 2-methoxy-4-(5-methyl-3,6-dihydro-2H-pyran-2-yl) phenol, 4-[(allyloxy) methyl]-2-ethoxyphenol, 2-methoxy-4-(oxolan-2-yl)phenol, 2-ethoxy-4-(ethoxymethyl)phenol, 3-(4-hydroxy-3-methoxyphenyl)prop-2-enal, 3-(4-hydroxy-3,5-dimethoxyphenyl)prop-2-enoic acid, 2,4-dimethoxyacetophenone, 2,4-dimethoxybenzaldehyde, 2-hydroxy-4-methoxyacetophenone, 2-(4-hydroxy-3-methoxyphenyl)acetic acid, methyl 3-(3,4-dimethoxyphenyl)-2-methylpropanoate, (2,3-dimethoxyphenyl)methanol, 2,3,4-trimethoxybenzonitrile, 2,3,4-trimethoxybenzaldehyde, 3,4,5-trimethoxybenzaldehyde and 3-ethoxy-4-methoxybenzaldehyde managed to elicit repellence above 75% (Table 3).

At the highest tested concentrations, i.e. 1%, thirty tested compounds, i.e methyl 3-(3,4-dimethoxyphenyl)-2-methylpropanoate, (2-formyl-5-methoxyphenyl)acetate, 7-methyl-1,5-benzodioxepin-3-one, 1-(2,3,4-trimethoxyphenyl)ethenone, 1,2-dimethoxy-4-prop-1-enylbenzene, 2-methoxy-4-(1-methoxyethyl)phenol, 1,2,3-trimethoxy-5-methylbenzene, 1,2,3-trimethoxybenzene, (3,4,5-trimethoxyphenyl)methanol, 2-ethoxy-4-methylphenol, 3-(3,4,5-trimethoxyphenyl)-2-propenyl acetate, 2-ethoxy-1,3-dimethoxybenzene, 2-hydroxy-4-methoxyacetophenone, 2-(4-hydroxy-3-methoxyphenyl)acetic acid, 4-[(allyloxy) methyl]-2-ethoxyphenol, 2-methoxy-4-(oxolan-2-yl)phenol, (2,3-dimethoxyphenyl)methanol, 2,4-dimethoxyacetophenone, 2-ethoxy-4-(methoxymethyl)phenol, 2,3,4-trimethoxybenzaldehyde, 2-ethoxy-4-(ethoxymethyl)phenol, 4-{3-[(2,6-dimethyl-7-octen-2-yl)oxy]-1-propen-1-yl}-2-methoxyphenol, 3,4,5-trimethoxybenzaldehyde, (2-ethoxy-4-formylphenyl) 2-methylpropanoate, 4-ethyl-2,6-dimethoxyphenol, 1,2-dimethoxy-3-prop-1-enylbenzene, 2,3,4-trimethoxyphenol, 8-hydroxy-7-methoxychromen-2-one, 1,2,3-trimethoxy-5-prop-2-enylbenzene and 1,2,3-trimethoxy-5-prop-1-enylbenzene, managed to elicit repellence >90%, i.e. to have less than 3 mosquitoes landing per minute compared to 29 mosquitoes landing per minute without any stimulus applied (Table 3). Ten tested stimulus, i.e methyl 3-(3,4-dimethoxyphenyl)-2-methylpropanoate, (2-formyl-5-methoxyphenyl)acetate, 7-methyl-1,5-benzodioxepin-3-one, 1-(2,3,4-trimethoxyphenyl)ethenone, 1,2-dimethoxy-4-prop-1-enylbenzene, 2-methoxy-4-(1-methoxyethyl)phenol, 1,2,3-trimethoxy-5-methylbenzene, 1,2,3-trimethoxybenzene, (3,4,5-trimethoxyphenyl)methanol and 2-ethoxy-4-methylphenol, managed to protect the attractive stimulus for any mosquito landing within the two minutes of experiments (Table 3).

TABLE 4
Percentage of repellence of mosquitoes Anopheles gambiae
landing on the warm body baited with different
stimuli at different concentrations.

| | 0.178 | 0.267 | 0.4 | 4.47 | 10 |
|---|---|---|---|---|---|
| | mg/mL | mg/mL | mg/mL | mg/mL | mg/mL |
| 908 | 61% | 95% | 51% | 74% | 84% |
| 1228 | 48% | 85% | 65% | 92% | 100% |
| 1232 | 27% | 34% | 65% | 91% | 86% |
| 1564 | 42% | 58% | 9% | 97% | 97% |
| 1967 | 65% | 78% | 84% | 100% | 100% |
| 1141 | n.d. | n.d. | n.d. | 100% | 69% |
| 1271 | n.d. | n.d. | n.d. | 95% | 92% |
| 1468 | n.d. | n.d. | n.d. | 59% | 79% |

The eight stimuli tested were 1-(5-propyl-1,3-benzodioxol-2-yl)ethanone (908), 7-methyl-1,5-benzodioxepin-3-one (1228), isopropyl-2H,4H-1,5-benzodioxepin-3-one, 7- (1232), 2-(3,4-dimethoxyphenyl)acetic acid (1564), 3,4,5-trimethoxytoluene (1967), (2-methoxy-4-methylphenyl) methyl carbonate (1141), 2-ethoxy-4-(methoxymethyl)phenol (1271), 1-(4-hydroxy-3-methoxyphenyl)ethanone (1468). Two to five concentrations were assessed on each stimulus, n.d. meaning no data. The mean number of mosquito landings with the solvent only (0 mg/mL) is equal to 46 ± 9.4 landings in two minutes.

At the two highest concentrations tested, i.e. 0.447% & 1%, the percentage of repellence was above 75% for all products for at least one of the two concentrations (Table 4). 7-Methyl-1,5-benzodioxepin-3-one, 3,4,5-trimethoxytoluene and (2-methoxy-4-methylphenyl) methyl carbonate managed to have no mosquito landing on the attractive stimulus with at least one of these two concentrations, i.e. 100% repellence, demonstrating the high repellent efficacy of the ingredients s against Anopheles gambiae (Table 4). With 3,4,5-trimethoxytoluene, even at the lowest concentration tested, i.e. 0.0178%, the percentage of repellence was already above 60% (Table 4).

TABLE 5
Percentage of repellence of mosquitoes Anopheles gambiae
landing on the warm body baited with different
stimuli at different concentrations.

| | | 1228 | 1967 | 1975 |
|---|---|---|---|---|
| 0.0032 | mg/mL | 0% | 0% | 0% |
| 0.0071 | mg/mL | n.d. | n.d. | 5% |
| 0.016 | mg/mL | n.d. | 0% | 78% |
| 0.053 | mg/mL | n.d. | n.d. | 23% |
| 0.08 | mg/mL | 0% | 1% | 0% |
| 0.178 | mg/mL | 48% | 59% | n.d. |
| 0.267 | mg/mL | 71% | 82% | n.d. |
| 0.4 | mg/mL | 66% | 71% | 94% |
| 0.598 | mg/mL | 69% | n.d. | n.d. |
| 2 | mg/mL | 92% | 100% | 95% |
| 4.47 | mg/mL | 92% | 100% | 100% |
| 10 | mg/mL | 100% | 100% | 98% |

The three stimuli tested were 7-methyl-1,5-benzodioxepin-3-one (1228), 3,4,5-trimethoxytoluene (1967) and 1,2,3-trimethoxy-5-propylbenzene (1975). Nine concentrations were assessed on each stimulus, n.d. meaning no data. The mean ± SD number of mosquito landings with the solvent only (0 mg/mL) is equal to 51.3 ± 5.8 landings in two minutes.

As soon as the stimulus concentration applied on the warm body was ≥0.2%, the number of Malaria mosquito landings was reduced by >90% (Table 5). 3,4,5-Trimethoxytoluene even managed to >50% of repellence as soon as the concentration was ≥0.0178% and elicited no landing at all as soon as concentrations ≥0.2% (Table 5). 1,2,3-trimethoxy-5-propylbenzene obtained >90% repulsion at all doses ≥0.04% applied on the Warm Body (Table 5).

### Dual Chamber Assay

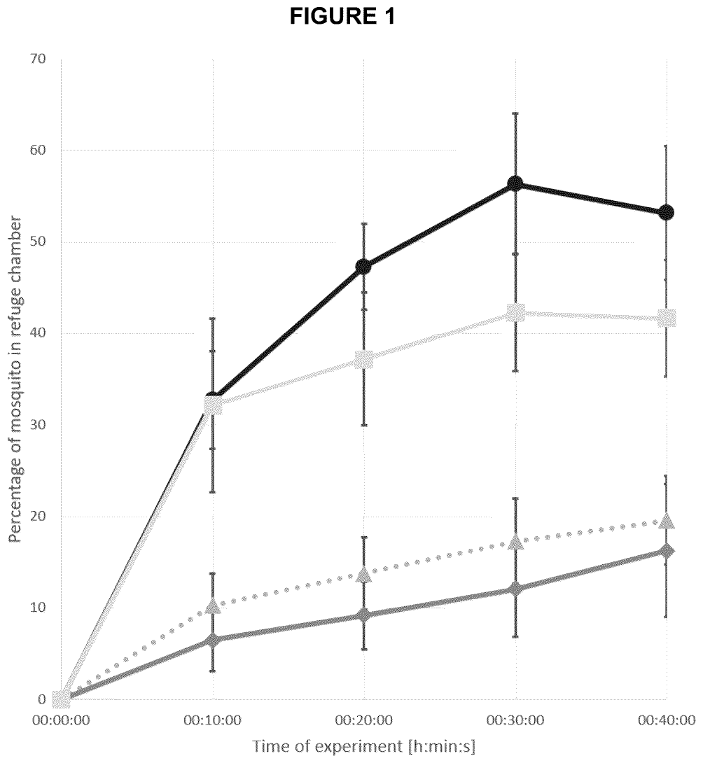

As displayed in FIG. 1, treating the chamber containing the mosquitoes Aedes aegypti with the solvent, i.e. propan-1,2-diol, used to dilute the three stimuli, i.e. N,N-diethyl-meta-toluamide (DEET), 2,6-dimethoxy-4-methylphenol and 1,2,3-trimethoxy-5-propylbenzene, did not elicit a strong migration towards the untreated chamber, i.e. only 19.5%±4.8% of the mosquitoes moved to the refuge chamber after 40 min. Unexpectedly, the results with DEET was similar with only 16.2%±7.3% of movement towards the refuge chamber after 40 min of injection in the treated chamber containing the mosquitoes (FIG. 1). In the other hand, both products covered by this patent demonstrated a quick and strong effect of repellence, forcing >30% of the mosquitoes to move within the first 10 min of injection to reach a plateau close to 42% and 54% for 2,6-dimethoxy-4-methylphenol and 1,2,3-trimethoxy-5-propylbenzene respectively after 30 min of injection (FIG. 1).

### Arm in Cage Assay

TABLE 6
arm in cage results on three human volunteers with arm
treated with 20% of 1,2,3-trimethoxy-5-propylbenzene

Number of mosquitoes landing on

| | the untreated | the treated |
|---|---|---|
| | arm (control) | arm (test) |
| Volunteer#1 | 450 | 1 |
| Volunteer#2 | 462 | 3 |
| Volunteer#3 | 492 | 5 |

As demonstrated in the Table 6, application of 1,2,3-trimethoxy-5-propylbenzene allowed to protect the arm of all three human volunteers by reducing the number of mosquito Aedes aegypti landings by 99.4%±0.4%.

TABLE 7
arm in cage results on three human volunteers with arm treated
with 20% of 7-methyl-1,5-benzodioxepin-3-one over time

Number of mosquitoes landing on

| | | | the untreated | the treated |
|---|---|---|---|---|
| | | | arm (control) | arm (test) |
| Time Post- | 30 | min | 50.3 ± 4.5 | 0 |
| application | 1 | h | 46.7 ± 2.0 | 0 |
| | 2 | h | 44.0 ± 4.8 | 3.0 ± 1.8 |
| | 3 | h | 37.5 ± 1.8 | 7.5 ± 1.1 |

As demonstrated in the Table 7, application of 7-methyl-1,5-benzodioxepin-3-one allowed to obtain a Complete Protection Time (no confirmed landing) for 1.33 h against Anopheles gambiae. At 3 h, the protection was still of 79.64% on two volunteers (Table 7). It is worthwhile to note that the commonly used repellent IR3535, at the same concentration and using the same protocol, only obtained a CPT of 0.17 h (data not displayed).

### Free Flying Room Assay

TABLE 8
Air repellence efficacy of three compounds against
Aedes aegypti in large scale assay.

| | release | | |
|---|---|---|---|
| | amount | Spatial | Protective |
| | [mg/h] | Repellence | efficacy |
| 2,6-dimethoxy-4-methylphenol | 178 ± 20 | 64.3 ± 3.4% | 75.8 ± 3.9% |
| 3,4,5-trimethoxytoluene | 193 ± 27 | 47.3 ± 3.8% | 63.1 ± 5.5% |
| 1,2,3-trimethoxy-5- | 338 ± 25 | 43.9 ± 9.1% | 74.2 ± 4.4% |
| propylbenzene | | | |

During the negative control test, i.e. the room with the volunteer was not treated with a stimulus, 82.5±3.7% of the mosquito moved from the release room to the room with the volunteer through the window. The volunteer received 60.7±2.5 landings in 3 minutes, mosquitoes in the room landed 1.4±0.1 times to try biting the volunteer. As displayed in Table 8, all three tested compounds significantly decreased the mosquito entrance in the room with the volunteer and decreased the number of potential bites by >60% compared to a situation with a non-treated chamber. With 2,6-dimethoxy-4-methylphenol, only 29.5±2.8% of the mosquito entered the treated chamber and only 14.7±2.5 mosquitoes landed on the volunteer, giving the protective values listed in Table 8. With 3,4,5-trimethoxytoluene, only 43.5±3.2% of the mosquito entered the treated chamber and 22.3±3.2 mosquitoes landed on the volunteer, giving the protective values listed in Table 8. With 1,2,3-trimethoxy-5-propylbenzene, only 46.3±7.5% of the mosquito entered the treated chamber and 15.7±3.1 mosquitoes landed on the volunteer, giving the protective values listed in Table 8.

### Warm Plate Assay

TABLE 9
Percentage of repellence of ticks Ixodes ricinus on the warm
plate baited with a stimulus at three different concentrations.

| | 0 | 0.4 | 2 | 10 |
|---|---|---|---|---|
| | mg/mL | mg/mL | mg/mL | mg/mL |
| 1,2-dimethoxy-3-prop-1- | 0% | 25.0% | 36.4% | 91.7% |
| enylbenzene | | | | |

As displayed in Table 9, 1,2-dimethoxy-3-prop-1-enylbenzene managed to repel the ticks Ixodes ricinus in a dose response manner, reaching a total above 90% of repellence with 1% of stimulus applied.

TABLE 10
Percentage of repellence of ticks Ixodes ricinus on the warm
plate baited with 12 stimuli at three different concentrations.

| | 0 | 0.4 | 2 | 10 |
|---|---|---|---|---|
| | mg/mL | mg/mL | mg/mL | mg/mL |
| 1141 | 0.0% | 8.3% | 58.3% | 66.7% |
| 1191 | 0.0% | 41.7% | 58.3% | 91.7% |
| 1195 | 0.0% | 46.2% | 76.9% | 100.0% |
| 1201 | 0.0% | 0.0% | 23.1% | 100.0% |
| 1472 | 0.0% | 0.0% | 54.5% | 100.0% |
| 1479 | 0.0% | 66.7% | 100.0% | 100.0% |
| 1482 | 0.0% | 30.8% | 66.7% | 100.0% |
| 1537 | 8.3% | 16.7% | 58.3% | 72.7% |
| 1557 | 8.3% | 25.0% | 69.2% | 66.7% |
| 1558 | 0.0% | 16.7% | 38.5% | 91.7% |
| 1559 | 0.0% | 13.3% | 57.1% | 91.7% |
| 2267 | 0.0% | 66.7% | 86.7% | 71.4% |

The twelve stimuli tested were (2-methoxy-4-methylphenyl) methyl carbonate [1141], 4-allyl-2,6-dimethoxyphenol [1191], 1,2-dimethoxy-4-prop-1-enylbenzene [1195], 1,2,4-trimethoxybenzene [1201], (2-formyl-5-methoxyphenyl) acetate [1472], 4-[(allyloxy)methyl] -2-ethoxyphenol [1479], 2-ethoxy-4-(ethoxymethyl)phenol [1482], 2,6-dimethoxy-4-methylphenol [1537], 2,4-dimethoxyacetophenone [1557], 2,4-dimethoxybenzaldehyde [1558], 2-hydroxy-4-methoxyacetophenone [1559], 2,3,4-trimethoxybenzaldehyde [2267].

As displayed in Table 10, all the twelve stimuli managed to repel the ticks Ixodes ricinus in a dose response manner. All the twelve stimuli repelled at least ⅔ of the tested ticks at the highest concentration tested of 1%. Five compounds, 1,2-dimethoxy-4-prop-1-enylbenzene, 1,2,4-trimethoxybenzene, (2-formyl-5-methoxyphenyl)acetate, 4-[(allyloxy)methyl]-2-ethoxyphenol and 2-ethoxy-4-(ethoxymethyl)phenol, even managed to repel all the ticks at this concentration of 1% (Table 10). 4-[(Allyloxy)methyl]-2-ethoxyphenol was the most efficient tested compound as it already repelled ⅔ of the tested ticks at the lowest tested concentration of 0.04% and then repelled all ticks at the two subsequent tested concentrations of 0.2% and 1% (Table 10).

1. An arthropod, preferably insect, control composition comprising a compound of formula (I) 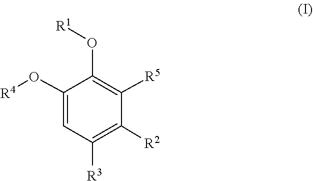
in the form of any one of its stereoisomers or a mixture thereof and wherein, R¹ is a hydrogen atom, a C₁₋₃ alkyl group or a C(═O)(O)ₙR^{1′} wherein n is 0 or 1 and R^{1′} is a C₁₋₃ alkyl group; R² is an hydrogen atom, a hydroxy group, an acetyl group, a formyl group, a nitrile group, a methyl group, or a methoxy group; R³ is a hydrogen atom, a C₄₋₇ oxacycloalkyl or oxacycloalkenyl group, each optionally substituted with a C₁₋₃ alkyl or a methylene group, a C₁₋₅ alkyl or C₂₋₅ alkenyl group, each optionally substituted by an oxo group, a COOH group, an acetate group, a COOMe group, a COOEt group or a OR^{3′} group wherein R^{3′} is a hydrogen atom or C₁₋₁₀ alkyl group or a C₂₋₁₀ alkenyl group; R⁴ is a hydrogen atom or a C₁₋₃ alkyl group; R⁵ is a hydrogen atom, a C₂₋₃ alkenyl group, a hydroxymethyl group or a OR^{5′} group wherein R^{5′} is a hydrogen atom or a C₃ alkyl group; or R¹ and R⁴, when taken together, are a CH₂C(═O)CH₂ group, a methanediyl group or a 2-oxopropane-1,1-diyl group;
provided that
when R⁵ is a hydrogen atom; then R¹, R² and R³ are not a hydrogen atom;
when R⁵ is a hydrogen atom; R¹ is a hydrogen atom or a methyl group and R⁴ is a methyl group; then R³ is not an unsubstituted C₁₋₅ alkyl or C₁₋₅ alkenyl group;
when R³ is a formyl group; then R¹ and R⁴ is not a methyl group and R⁵ is not a hydrogen atom;
when R¹ is a hydrogen atom and R⁵ is a methoxy group; then R³ is not a formyl group;
an acetyl group or a 2-carboxyvinyl group;
when R² is a methoxy group; then R³ is not a prop-1-en-1-yl group;
4-hydroxy-3-methoxybenzaldehyde, 4-butoxymethyl-2-methoxyphenol, 4-(4-hydroxy-3-methoxyphenyl)-2-butanone, 3-(4-hydroxy-3-methoxyphenyl) prop-2-enal, 4-hydroxy-3-methoxybenzaldehyde and 3-(3,4-dimethoxyphenyl) prop-2-enoic acid are excluded.

2. The arthropod control composition of claim 1 wherein compound of formula (I) is of formula 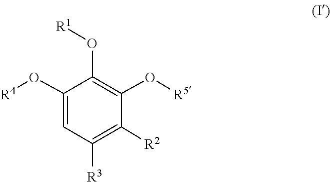
wherein R¹, R², R³, R⁴ and R^{5′} have the same meaning as defined in claim 1.

3. The arthropod control composition of claim 1 wherein the compound is selected from a list consisting of: 2,6-dimethoxy-4-[prop-1-enyl]phenol, 4-allyl-2,6-dimethoxyphenol, 1,2,3-trimethoxy-5-[1-propen-1-yl]benzene, 1,2,3-trimethoxy-5-propylbenzene, 1,2,4-trimethoxybenzene, 2,6-dimethoxy-4-propylphenol, 2,6-dimethoxy-4-methylphenol, 3-(3,4,5-trimethoxyphenyl)prop-2-enoic acid, 2-(4-hydroxy-3-methoxyphenyl)acetic acid, methyl 3-(3,4-dimethoxyphenyl)-2-methylpropanoate, (2,3-dimethoxyphenyl)methanol, 2,3,4-trimethoxybenzaldehyde, 3,4,5-trimethoxybenzaldehyde, 2-ethoxy-4-(methoxymethyl)phenol, 2-ethoxy-4-(ethoxymethyl)phenol, 1,2-dimethoxy-4-prop-1-enylbenzene, 1,2,3-trimethoxy-5-methylbenzene, 2,6-dimethoxy-4-methylphenol, 1-(2,3,4-trimethoxyphenyl)ethanone, 7-methyl-1,5-benzodioxepin-3-one, 1,2-dimethoxy-3-prop-1-enylbenzene, 1,2,3-trimethoxy-5-propylbenzene, 2,3,4-trimethoxybenzonitrile, 3-ethoxy-4-methoxybenzaldehyde, 2,3,4-trimethoxyphenol, 1-(4-hydroxy-3-methoxyphenyl)ethanone, 2-methoxy-4-(4-methylideneoxan-2-yl)phenol, 4-(3,6-dihydro-4-methyl-2H-pyran-2-yl)-2-methoxy-phenol and mixtures thereof.

4. The arthropod control composition of claim 3 wherein the compound is selected from a list consisting of: 6-dimethoxy-4-[prop-1-enyl]phenol, 4-allyl-2,6-dimethoxyphenol, 1,2,3-trimethoxy-5-[1-propen-1-yl]benzene, 1,2,3-trimethoxy-5-propylbenzene, 1,2,4-trimethoxybenzene, 2,6-dimethoxy-4-propylphenol, 2,6-dimethoxy-4-methylphenol, 3-(3,4,5-trimethoxyphenyl)prop-2-enoic acid, 2-(4-hydroxy-3-methoxyphenyl)acetic acid, methyl 3-(3,4-dimethoxyphenyl)-2-methylpropanoate, (2,3-dimethoxyphenyl)methanol, 2,3,4-trimethoxybenzaldehyde, 3,4,5-trimethoxybenzaldehyde, 2-ethoxy-4-(methoxymethyl)phenol, 2-ethoxy-4-(ethoxymethyl)phenol and mixtures thereof.

5. The arthropod control composition according to any of the previous claims, wherein the arthropod is an insect, preferably a mosquito.

6. The arthropod control composition according to any one of claims 1 to 5, further comprising an arthropod control co-ingredient being selected from the group consisting of: N,N-diethyl-3-methylbenzamide (DEET), ethyl butylacetylaminopropionate (IR3535); para-menthan-3,8-diol (PMD); 1-(1-methylpropoxycarbonyl)-2-(2-hydroxaethyl) piperidin (picaridin); Cedarwood oil China, Cedarwood oil Texas, Cedarwood oil Virginia, Cinnamon oil, Citronella oil, Cornmint oil, Cymbopogon winterianus oil fractionated hydrated cyclized, decanoic acid, Eucalyptus citriodora oil Eucalyptus citriodora oil hydrated cyclized, eugenol, Garlic oil, geraniol, Geranium oil, Lavender, Lavandula hybrida oil, Lavandin oil, Lemon oil, Lemongrass oil, Margosa extract, Metofluthrin, mixture of cis-and trans-p-menthane-3,8 diol, N,N-diethyl-meta-toluamide, nonanoic acid, Rosemary oil, Thyme oil, Wintergreen oil, 2,3,4,5-bis (butyl-2-ene)tetrahydrofurfural (MGK Repellent 11), cineole, cinnamaldehyde, citronellal, citronellol, coumarin, dibutyl phthalate, diethyl phthalate, dimethyl anthranilate, dimethyl phthalate, ethyl vanillin, Eucalyptus oil, delta-octalactone, delta-nonalactone, delta-decalactone, delta-undecalactone, delta-dodecalactone, gamma-octalactone, gamma-nonalactone, gamma-decalactone, gamma-undecalactone, gamma-dodecalactone, hydroxy citronellal, Lime oil, limonene, linalool, methyl anthranilate, Mint oil, myrcene, Neem oil, sabinene, β-caryophyllene, (1H-indol-2-yl)acetic acid, anethole, Anise oil, Basil oil, Bay oil, camphor, ethyl salicylate, Evergreen oils (pine oil), (1,3,4,5,6,7-hexahydro-1,3-dioxo-2H-isoindol-2-yl)methyl 2,2-dimethyl-3-(2-methylprop-1-enyl)cyclopropanecarboxylate (d-Tetramethrin), 3-Allyl-2-methyl-4-oxocyclopent-2-enyl-2,2-dimethyl-3-(2-methylprop-1-enyl)-cyclopropanecarboxylate (d-Allethrin), α-cyano-3phenoxybenzyl, 3-(2,2-dichlorovinyl)-2,2-dimethylcyclopropanecarboxylate (Cypermethrin), 2-methyl-4-oxo-3-(prop-2-ynyl)cyclopent-2-en-1-yl 2,2-dimethyl-3-(2-methylprop-1-enyl)cyclopropanecarboxylate (Prallethrin), Acetamiprid, Azadirachtin, Bendiocarb, Bifenthrin, boric acid, Chlorpyrifos, Deltamethrin, Diazinon, Dichlorvos, eugenol, Fipronil, Imidacloprid, linalool, Malathion, Maltodextrin, Metofluthrin, Nicotine, Permethrin, Pyrethrins, Pyrethroids, Rotenone, silicium dioxide (Kieselguhr), S-Methoprene, Spinosad (Spinosyn A), Spinosyn D, Tetramethrin, Transfluthrin, 1-(2,6,6-trimethylcyclohex-2-en-1-yl)but-2-en-1-one, 3-butylidene-2-benzofuran-1-one, 4-ethenyl-2-methoxyphenol, Cognac oil green, Labdanum extract (Cistus spp.), 5-pentyloxolan-2-one, chromen-2-one, 3,7-dimethylocta-2,6-dienal, 4-hydroxy-3-methoxybenzaldehyde, 2-methyl-5-prop-1-en-2-ylcyclohex-2-en-1-one, Mentha spicata oil, 6-hexyloxan-2-one, 5-methyl-2-propan-2-ylcyclohexyl]acetate, Nigella damascena oil, 2-phenylethanol, 6-pentyloxan-2-one, (4-methoxyphenyl)methyl acetate, Syzygium aromaticum oil, 3,4,4a,5,6,7,8,8a-octahydrochromen-2-one, 3,7,7-trimethylbicyclo[4.1.0]hept-3-ene, 2-phenylethyl 2-methylpropanoate, methyl 2-(3-oxo-2-pent-2-enylcyclopentyl)acetate, 4-(2-methoxypropan-2-yl)-1-methylcyclohexene, Mentha piperita oil, 2-methoxy-4-[prop-1-enyl]phenol, 2-methyl-3-(4-propan-2-ylphenyl)propanal, (4-methoxyphenyl)methanol and mixtures thereof.

7. A method for arthropod, preferably insect, control which comprises bringing an insect into direct contact or in contact with vapors of a composition as defined in claims 1 to 6.

8. Use of a composition as defined in any one of claims 1 to 6 to control arthropods, preferably insects.

9. An arthropod, preferably insect, control article comprising the arthropod, preferably insect, control composition according to any one of claims 1 to 6.

10. The arthropod control article according to claim 9, wherein the article is a consumer product.

11. The arthropod control article according to any one of claims 9 and 10, wherein the article is a fabric care product, such as a liquid or solid detergent, a fabric softener, a liquid or solid scent booster, a fabric refresher, an ironing water, a paper, a bleach, a carpet cleaner, a curtain-care product; a body-care product, such as a hair care product (e.g. a shampoo, a coloring preparation or a hair spray, a color-care product, a hair shaping product, a dental care product), a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc. . . . ); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner; a candle; a spray; a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint.

12. The arthropod control article according to claims 9 to 11, wherein the article is an air care product, preferably an electric diffuser.
